(19) United States
(12) Patent Application Publication
(10) Pub. No.: US 2026/0204860 A1
(43) Pub. Date: Jul. 16, 2026

(54) COMPOSITE LASER GAIN MEDIUM

(71) Applicant: Aqwest LLC, Larkspur, CA (US)

(72) Inventors: Jan Vetrovec, Larkspur, CO (US); David M. Filgas, Newbury Park, CA (US)

(73) Assignee: Aqwest LLC, Larkspur, CO (US)

(21) Appl. No.: 18/371,321

(22) Filed: Sep. 21, 2023

Related U.S. Application Data
(60) Provisional application No. 63/474,896, filed on Sep. 21, 2022.

(51) Int. Cl. H01S 3/063; B32B 17/06; B32B 37/06; B32B 38/00; H01S 3/16

(52) U.S. Cl. CPC H01S 3/0632; B32B 17/06; B32B 37/06; B32B 38/0012; H01S 3/1601

(57) ABSTRACT

The invention provides a method for fabricating composite LGM, especially PWG, offering excellent utilization of the starting material and reduced the number of production steps. In particular, the inventive method starts with core and cladding materials at or very near to their final thickness, performs an initial bonding of the core and the claddings using a commercial wafer bonding process (WBP), and strengthens the bond by heat treating. Surface preparation prior to the initial WBP is also less demanding than for optical contacting. The initial WBP bond is strong enough so that the in-process workpiece can be handled and heat treated without special tooling.

### PRIORITY

This patent application claims priority from U.S. provisional patent application U.S. Ser. No. 63/474.896, filed on Sep. 21, 2022 and entitled “Composite Laser Gain Medium” the entire contents of all of which are hereby expressly incorporated by reference.

### GOVERNMENT RIGHTS IN THIS INVENTION

None.

### CROSS-REFERENCE TO RELATED APPLICATIONS

None.

### FIELD OF THE INVENTION

This invention relates generally to bonding of dielectric materials and more specifically to forming composite laser gain media, especially planar waveguides.

### BACKGROUND OF THE INVENTION

The gain element in a solid-state laser may be advantageously formed as a planar waveguide (PWG). PWG offers an efficient, lightweight, and compact solution for laser sources operating in the regimes from continuous wave to short pulse modes. A clad-type planar waveguide (PWG) is an assembly comprising a core attached to a cladding, or a core sandwiched between two claddings, the latter being indicated in FIG. 1. The claddings provide means for pumping the core and for mitigating the deleterious amplified spontaneous emission (ASE). The core is made of laser quality optical material (glass, crystal, or ceramic) also known as a “host” material doped with suitable laser ions. The claddings are (typically) made of undoped optical material. Preferably, the cladding are made of the same host material as the core but not substantially doped by laser ions used in the core. The relationship between the refractive indices of the core and the claddings required to confine (“waveguide”) the signal beam through the core have been well established in prior art. See, e.g., U.S. Pat. No. 5,441,803 awarded to Meissner, which is hereby incorporated in its entirety. In a completed and laserable PWG, the thickness of the core may be typically from a few micrometers to a few hundred micrometers. The thickness of the claddings may be typically from a few tens of micrometers to a few hundred micrometers. The contact between the core and the cladding must be optically transparent at normal incidence with high clarity, thermally conductive, and preferably mechanically very robust.

In operation, the signal and pump beams co-propagate in the core. This arrangement provides a long path for efficient pump absorption and a high gain for signal amplification. In the thin direction of the PWG (parallel to the temperature gradient), the signal and pump beams are guided by total internal reflection as in a fiber. In the wider direction, the beams are collimated by the injection optics. The large faces of the PWG provide ample surface area for efficient cooling. For this purpose, one or both large faces of the PWG are arranged to be in contact with heat sinks. Due to its small thickness (typically 600 to 800 μm), a PWG temperature is essentially at the temperature of the heat sink to which it is thermally connected. This arrangement greatly reduces deleterious thermo-optical effects and thermo-mechanical stresses. As a result, the PWG offers amplification of laser beams having good beam quality (BQ) without much optical distortion.

Preferably, one or two claddings are permanently attached (bonded) to the core. In that case, the coefficient of thermal expansion (CTE) of material of the core and the material of the cladding(s) should be closely matched. Permanently attaching a thin cladding to a thin core has been traditionally very challenging. In particular, self-supporting thin members are typically difficult to produce and maintain in a flat condition. This condition may be caused by gravity and/or by internal or surface stresses, which may have been aggravated by fabrication. Therefore, such thin members are not very conducive to “optical contacting” which is a pre-requisite for the bonding process of prior art.

To work around this challenge, a production technique of prior art generally follows the following steps: First cladding provided in a thick form (typically>1 millimeters in thickness for every inch of maximum lateral dimension) is bonded to the core provided in a thick form (typically>1 millimeters in thickness for every inch of maximum lateral dimension) to form a 2-part assembly, FIG. 2. The 2-part assembly is then machined to bring the core thickness down to its final form. The resulting intermediate assembly may be subsequently bonded to the second cladding provided in a thick form (typically>1 millimeters in thickness for every inch of maximum lateral dimension). The resulting 3-part assembly is then machined to thin down the first and second claddings to their final thickness in the range indicated above. This results in a basic PWG with two claddings, which is now ready for final machining of the sides and later application of optical coatings.

The bonding process of the prior art comprises of “optical contacting followed by heat treatment bonding” and it is described in detail by said Meissner. Meissner also indicates the surface preparation required for a successful bond and conditions for the heat treatment. To maintain the surface flatness required for optical contacting necessitates that the core and the claddings must be provided in thick form as indicated above to avoid sagging or other distortions when free standing.

As a result, only a small fraction of the original material may remain in the completed PWG. This condition makes the PWG product very costly for at least two reasons: 1) Poor utilization of starting material and 2) Additional cost for machining away the unused material. Optical quality laser gain materials (LGM) for PWG construction such as glass, crystals, and ceramics may be not only costly but also very hard. This makes the machining away of the unused material an expensive operation. In summary, the lack of an economical and reliable bonding process for a PWG has impeded their wider adoption in laser sources for a range of commercial and Government applications.

### SUMMARY OF THE INVENTION

The present invention provides a method for fabricating a composite LGM, especially PWG, offering excellent utilization of the starting material and reduced the number of production steps. In particular, the inventive method starts with core and cladding materials at or very near to their final thickness, performs an initial bonding of the core and the claddings using a commercial wafer bonding process (WBP), and strengthens the bond by heat treating. Surface preparation prior to the initial WBP is also less demanding than for optical contacting. The initial WBP bond is strong enough so that the in-process workpiece can be handled and heat treated without special tooling. A PWG that has undergone such a heat treatment acquires a bond strength and resistance to bond reversal, which is greater than that of the untreated wafer-bonded-only PWG.

Accordingly, it is an object of the present invention to provide a simple and cost effective method for fabricating a composite laser gain medium.

It is another object of the invention to provide a simple and cost effective method for fabricating a PWG.

It is yet another object of the invention to provide high utilization of starting material when fabricating a PWG.

It is still another object of the subject invention to reduce the amount of machining when fabricating a PWG.

It is a further object of the subject invention to bond both claddings onto the PWG core in the same step.

These and other objects of the present invention will become apparent upon a reading of the following specification and claims.

### BRIEF DESCRIPTION OF THE DRAWINGS

FIG. 1 is a diagram showing a PWG concept for amplification of optical signal.

FIG. 2 is a diagram showing the PWG fabrication sequence of prior art.

FIG. 3 is a diagram showing the PWG fabrication sequence in accordance with the subject invention.

FIG. 4 is a diagram showing how pressure may be applied during the PWG fabrication process.

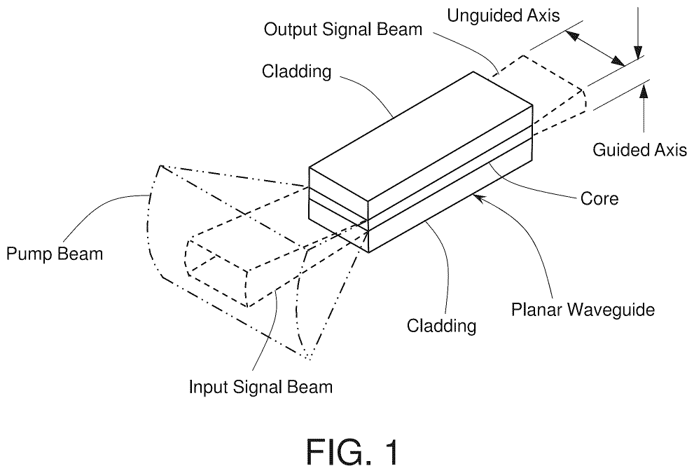

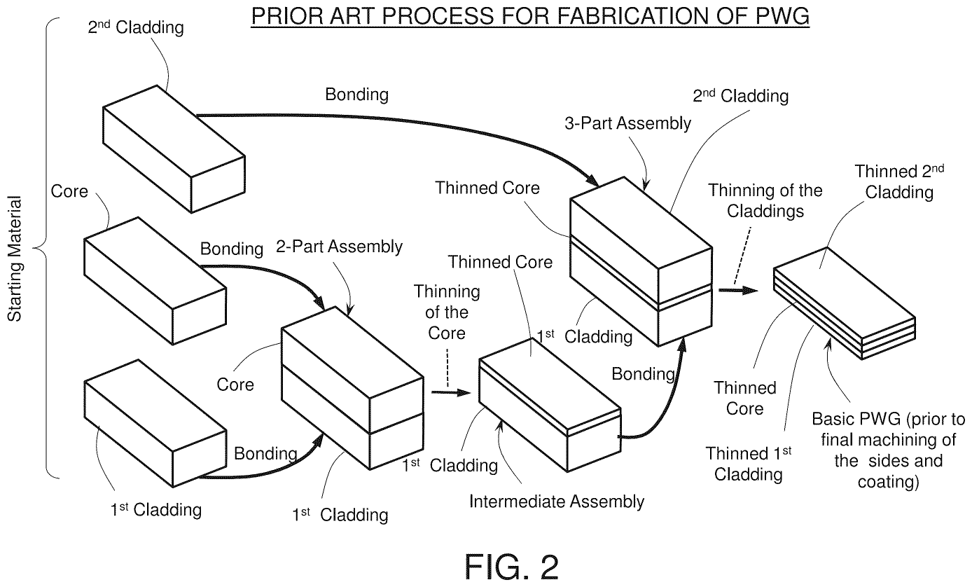

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

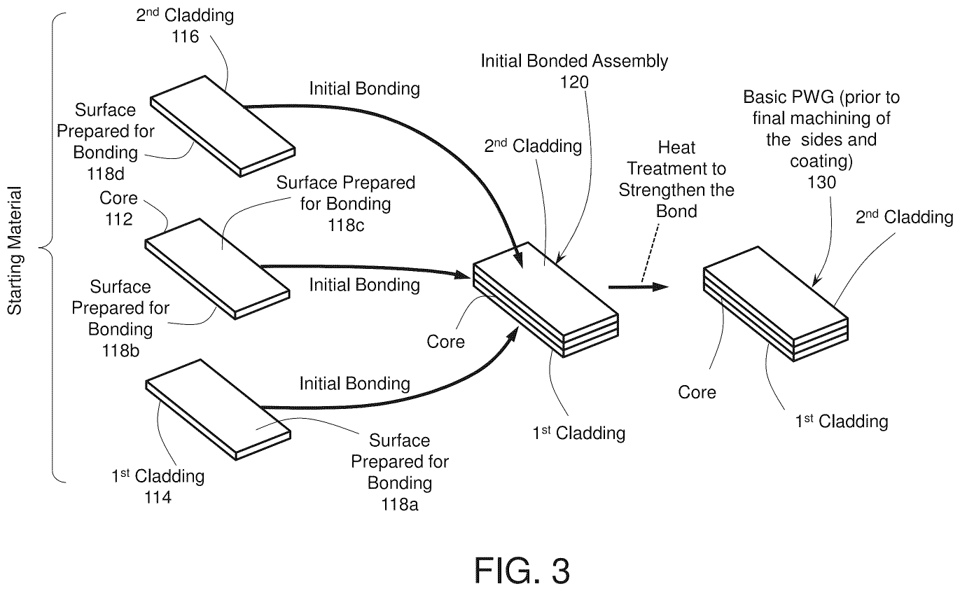

Referring now to FIG. 3, there is shown the innovative method for fabrication of a PWG with two claddings in accordance with the subject invention. The starting material is the PWG core 112 and the first cladding 114 and the second cladding 116, collectively referred to as the “claddings.” The material is preferably provided at or near to their final thickness to minimize the need for later machining. The footprint of the core or the claddings may generally be rectangular and approximating the targeted PWG shape, or it may be circular, or any other suitable shape. Preferably, the core and the claddings have the same shape and lateral dimensions. The thickness of the core 112 may be typically from a few micrometers to few hundred micrometers. The thickness of the claddings 114 and 116 may be typically from a few tens of micrometers to a few hundred micrometers. The material of the core 112 and the claddings 114 and 116 may be glass, crystal, or ceramic. For example, suitable crystals may include (but are not limited to) yittium aluminum garnet (YAG), yittrium lithium fluoride (YLF), gadolinium gallium garnet (GGG), and sapphire, while suitable polycrystalline ceramics may be YAG, lutecium sesquioxide (Lu₂O₃), yitrium sesquioxide (Y₂O₃), dysprosium sesquioxide (Dy₂O₃), and scandium sesquioxide (Sc₂O₃).. Suitable doping (laser) ions include (but are not limited to) trivalent yitterbium (Yb³⁺), trivalent neodymium (Nd³⁺), trivalent erbium (Er³⁺), trivalent holmium (Ho³⁺), trivalent thulium (Tm³⁺), and trivalent titanium (Ti³⁺). Preferably, the host material for the core is also used in the claddings. Alternatively, materials with similar thermal coefficient may be used. An example of a PWG for laser amplification in the vicinity of a 1030 nm wavelength may have a core made of Yb³⁺-doped YAG (Yb:YAG) and one or more claddings made of substantially undoped YAG. The YAG host material may be a single crystal or ceramic. An example of a PWG for laser amplification in the vicinity of a 2000 nm wavelength may have a core made of Tm³⁺-doped Lu₂O₃ (Tm:Lu₂O₃) and one or more claddings made of substantially undoped Lu₂O₃. The Lu₂O₃ host material may be a single crystal or ceramic. An example of a PWG for laser amplification in the general wavelength range of a 600-800 nm may have a core made of Ti³⁺-doped sapphire (Ti:S) and one or more claddings made of substantially undoped sapphire.

Surfaces of the core 112 that are to be bonded, or mated, are designated as 118b and 118c. Surfaces of the claddings 114 and 116 that are to be bonded, or mated, are respectively designated as 118a and 118d. The mating surfaces 118 to be bonded should be machined to optical flatness of less than of about 1/10th wave at 630 nm wavelength when measured in a restrained condition. For large size core and claddings, the mating surfaces 118 to be bonded should be machined to optical flatness of less than of about ⅕th wave at 630 nm wavelength over every 50 to 100 mm of lateral dimension when measured in a restrained condition. The surface smoothness is preferrably less than 1 nanometer root-mean-squared. The core 112 and the claddings 114 and 116 are arranged into a stack wherein said core is sandwiched between said claddings as indicated for the initial bonded assembly 120, and bonded to form the initial bonded assembly 120 using a commercial wafer bonding process (WBP) provided by Crystalline Mirror Solutions, a Division of Thorlabs Inc. located in Santa Barbara, CA. The Thorlabs process is at least in-part disclosed in the U.S. Pat. No. 10,559,936 awarded to Aspelmeyer et al. in the year 2020, which is hereby incorporated in its entirety. Unlike in the method of prior art, both claddings may be attached to the core at the same time. Bond produced by the wafer bonding process is known to be much stronger than conventional optical contacting disclosed by Meissner.

The Applicants have determined that the WBP can create a strong bond in YAG material that can withstand significant shear stress but it is still susceptible to separation when peeling is attempted. To strengthten the bond, the initial bonded assembly 120 is then heat treated in a furnace. Typically, a minumum heat treatment temperature of 80 degrees C may be necessary. An objective heat treating temperature should not exceed the temperature beyond which the PWG material transparency is significantly reduced. Typically, for single crystals the objective heat treating temperature may be as high as 90% of the material melting temperature. For polycrystalline materials (ceramics), this upper limit may be substantially lower. Preferably, the initial bonded assembly 120 is maintained at the heat treating temperature for 16 to 60 hours. Heating to and from the objective heat treating temperature is preferably conducted at 1 to 2 degrees C per minute until the objective temperature is reached. The heat treating atmosphere may be air at ambient or subambient pressure, an innert gas, reducing gas, or vacuum. The heat treating process stengthens the bonds and transforms the initial bonded assembly 120 into a basic PWG 130, which is now ready for final machining of the sides and later application of optical coatings. Referring now to FIG. 4, pressure may be applied across the large faces of the initial bonded assembly during heat treatment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof. The terms of degree such “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies. The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function. Different aspects of the invention may be combined in any suitable way. While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. A process for fabrication a planar waveguide (PWG) comprising a core attached to a cladding including the steps of:
(a) Machining the mating surfaces of said core and said cladding to be bonded to optical flatness;
(b) Polishing the mating surfaces of said core and said cladding to be bonded to a surface smoothness of less than 1 nanometer root-mean-squared;
(c) ;
(d) Bonding said core and said cladding by the wafer bonding process to form an initial bonded assembly; and
(e) Heat treating the initial bonded assembly to strengthen the bond.

2. The process of claim 1 wherein the step of machining achieves an optical flatness of less than 1/10th wavelength at 633 nm when measured in a restrained condition.

3. The process of claim 1 wherein the step of machining achieves an optical flatness of less than ⅕th wave at 630 nm wavelength over every 50-100 mm of lateral dimension when measured in a restrained condition.

4. The process of claim 1 wherein said step of heat treating is performed between 80 degrees C and 90% of the material melting temperature.

5. The process of claim 1 wherein said step of heat treating is performed for a period of 16 to 60 hours.

6. The process of claim 1 wherein the step of heat treating further includes transitioning of the initial bonded assembly from ambient temperature to the objective temperature and from the objective temperature to ambient temperature at a rate of 1 to 2 degrees C per minute.

7. The process of claim 1 wherein said core is made of a laser optical host material selected from the group consisting of YAG, YLF, GGG, sapphire, Lu₂O₃, Y₂O₃, Dy₂O₃, and Sc₂O₃, and doped with suitable laser ions selected from the group consisting of Yb³⁺, Nd³⁺, Er³⁺, Ho³⁺, Ti³⁺, and Tm³⁺.

8. The process of claim 1 wherein said cladding is made of the same laser optical host material as the core but without substantial doping with laser ions.

9. A planar waveguide (PWG) comprising a core and two claddings; wherein said core and claddings being bonded together by a process including the steps of:
(a) Machining the mating surfaces of said core and said claddings to be bonded to optical flatness;
(b) Polishing the mating surfaces of said core and said claddings to be bonded to a surface smoothness of less than 1 nanometer root-mean-squared;
(c) Bonding said core and said claddings concurrently by the wafer bonding process to form an initial bonded assembly wherein said core is sandwiched between said claddings; and
(d) Heat treating the initial bonded assembly to strengthen the bond.

10. The process of claim 9 wherein the step of machining achieves an optical flatness of less than 1/10th wave at 633 nm wavelength when measured in the restrained condition.

11. The process of claim 9 wherein the step of machining core and claddings with lateral size greater than about 50 mm achieves an optical flatness of less than ⅕th wave at 633 nm wavelength over every 50-100 mm of lateral dimension when measured in a restrained condition before the wafer bonding process.

12. The process of claim 9 wherein the step of heat treating occurs at conditions selected from the group consisting of ambient air, inert gas, reducing atmosphere, and vacuum.

13. The process of claim 9 wherein pressure is applied to the large faces of the initial bonded assembly during the heat treatment process.

14. A planar waveguide (PWG) for amplification of laser light comprising a core and a cladding:
(a) Said core being made of a laser optical host material selected from the group consisting of YAG, YLF, GGG, sapphire, Lu₂O₃, Y₂O₃, Dy₂O₃, and Sc₂O₃;
(b) Said laser optical host material of the core doped with suitable laser ions selected from the group consisting of Yb³⁺, Nd³⁺, Er³⁺, Ho³⁺, Ti³⁺, and Tm³⁺;
(c) Said cladding made of the same laser optical host materials as said core;
(d) Said cladding being bonded to said core by a wafer bonding process to form an initial bonded assembly; and
(e) Heat treating the initial bonded assembly to strengthen the bond.

15. The process of claim 13 wherein said core and said cladding are machined to achieve an optical flatness of less than 1/10th wave at 633 nm wavelength when measured in a restrained condition before the wafer bonding process.

16. The process of claim 13 wherein said core and said cladding are machined to achieve an optical flatness of less than ⅕th wave at 630 nm wavelength over every 50-100 mm of lateral dimension when measured in a restrained condition before the wafer bonding process.

17. The process of claim 13 wherein said heat treating is performed between 80 degrees C and 90% of the material melting temperature.

18. The process of claim 13 wherein said heat treating further includes transitioning of the initial bonded assembly from ambient temperature to the objective temperature and from the objective temperature to ambient temperature at a rate of 1 to 2 degrees C per minute.

19. The process of claim 13 wherein said heat treating occurs at conditions selected from the group consisting of ambient air, inert gas, reducing atmosphere, and vacuum.

20. The process of claim 13 wherein said heat treating is performed for a period of 16 to 60 hours.
